(19) United States
(12) Patent Application Publication
(10) Pub. No.: US 2011/0229051 A1
(43) Pub. Date: Sep. 22, 2011

(54) IMAGE PROCESSING CIRCUIT, INFORMATION REPRODUCING APPARATUS AND IMAGE PROCESSING METHOD

(75) Inventor: Koichiro Kakutani, Yokohama (JP)

(73) Assignee: PIONEER CORPORATION, Kanagawa (JP)

(21) Appl. No.: 13/130,933

(22) PCT Filed: Nov. 25, 2008
(86) PCT No.: PCT/JP2008/071359

§ 371 Date: May 24, 2011

(51) Int. Cl. G06K 9/40

(52) U.S. Cl. 382/254

(57) ABSTRACT

An image processing circuit (1) of the present invention is provided with: a difference calculating device (100) for calculating difference value between a pixel level of a focused pixel and a pixel level of a referenced pixel; a first comparing device (100) for comparing the difference value with a first threshold; a counting device (110) for judging the referenced pixel that the difference value is less than or equal to a predetermined threshold to be a valid pixel, and counting the number of the valid pixels; a second comparing device (120) for comparing the number of the valid pixels with a second threshold; and a correcting device (12) for correcting the pixel level of the focused pixel, in case that the number of the valid pixels is more than or equal to a second threshold.

### TECHNICAL FIELD

The present invention relates to an image processing circuit, and an information reproducing apparatus which containing the image processing circuit for expanding the number of bits of data, such as digital image data.

### BACKGROUND ART

In digital image data or video data, information of brightness, color difference or the like is generally quantized by 8 bit and compressed by using image compression technique such as MPEG (Moving Picture Experts Group). Each of the quantized information of brightness, color difference or the like only contains information of gray scale of 256 steps which is much less than original gray scale expressed in film of movies or the like. In case of reproduction of such compressed image data, because of the quantization before the compression and quantization during the processing the compression, the quantization error increased, and the information in the data reduced further. When the decoded data is merely displayed on the display, the displayed image can only be expressed with less gray scale than original image or film such as movie contains In addition, there is a part where the gray scale actually expressible with less than the gray scale of 8 bits of data before the compression, because of the above-mentioned reason.

When image data including the part has less information per a pixel is than original image data have, the sign extension for enhancing the number of bits per a pixel is performed, in order to reduce the quantization error.

As the technique of such bit enhancing process, the method for averaging the pixel level of the focused pixel as a target of the bit enhancing and the pixel level of the referenced pixel of the focused pixel is adopted so far. For example, at this time, there is also a method for averaging during limiting the pixel level so as not to cause deviation in the pixel level of the referenced pixel.

For example, a method for decreasing noise in the image, by combining the pixel level of each of referenced pixels located point-symmetrically with respect to a focused pixel, and averaging by using a pair of the referenced pixels located point-symmetrically in which both of the referenced pixels satisfy some predetermined requirement, in order to suppress the defection in the averaging process caused by the deviation of pixel level found in the edge portion of the image, is disclosed in patent document 1.

Moreover, a method for performing a sign extension, by evaluating the flatness that indicates the degree of changes of brightness between the pixels adjacent to each other respectively in the predetermined range is disclosed in patent document 2.

Patent document 1: Japanese Patent Application Laid Open No. 2002-259962

Patent document 2: Japanese Patent Application Laid Open No. 2008-47986

### DISCLOSURE OF INVENTION

### Subject to be Solved by the Invention

However, there is a technical problem in the conventional sign extension, that the appropriate sign extension cannot be carried out in case that there are pixels in the edge portion located adjacent to the focused pixel, because the pixel level of the pixels in the edge portion is very different from the pixel of the focused pixel or referenced pixels other than in the edge portion. Therefore, a method placing importance of existence of pixels with the pixel level greatly different from adjacent pixels, such as pixels in the edges of the image or prominent points of the pixel level is considered.

The method disclosed in the patent document 1 can achieve reduction of noise caused by pixels in the edge portion, but it can also be the reason of reduction in the number of pixels can be used for averaging. Therefore, by using such method, the effect of the sign extension for bringing the number of bit close to the original gray scale by averaging the pixels levels cannot be fully achieved.

In view of the aforementioned problems, it is therefore an object of the present invention to provide an image processing circuit, an information reproducing apparatus, computer program and an image processing method possible to perform excellent sign extension after suppressing the effect to averaging of pixel levels caused by the edges of the image and the prominent points.

### Means for Solving the Subject

The above object of the present invention can be achieved by An image processing circuit provided with: a difference calculating device for calculating difference value between a pixel level of a focused pixel and a pixel level of a referenced pixel; a first comparing device for comparing the difference value with a first threshold; a counting device for judging the referenced pixel that the difference value is less than or equal to a predetermined threshold to be a valid pixel, and counting the number of the valid pixels; a second comparing device for comparing the number of the valid pixels with a second threshold; and a correcting device for correcting the pixel level of the focused pixel, in case that the number of the valid pixels is more than or equal to a second threshold.

The above object of the present invention can be also achieved by an information reproducing apparatus provided with one of the image processing circuit written in claim 1 to claim 6.

The above object of the present invention can be also achieved by an image processing method provided with: a difference calculating process of calculating difference value between a pixel level of a focused pixel and a pixel level of a referenced pixel; a first comparing process of comparing the difference value with a first threshold; a judging process of judging the referenced pixel corresponding to the difference value which is less than or equal to the first threshold to be a valid pixel, and counting the number of the valid pixels; a second comparing process of comparing the number of the valid pixels with a second threshold; and a correcting process of correcting the pixel level of the focused pixel, in case of that the number of the valid pixels is more than or equal to a second threshold.

The above object of the present invention can be also achieved by an image processing method provided with: a difference calculating process of calculating difference value between a pixel level of a focused pixel and a pixel level of a referenced pixel; a first comparing process of comparing the difference value with a first threshold; a counting process of judging the referenced pixel that the difference value is less than or equal to a predetermined threshold to be a valid pixel, and counting the number of the valid pixels; a second comparing process of comparing the number of the valid pixels with a second threshold; and a correcting process of correcting the pixel level of the focused pixel, in case that the number of the valid pixels is more than or equal to a second threshold.

### BRIEF DESCRIPTION OF DRAWINGS

FIG. 1 is a block diagram conceptually showing the configuration of the computing unit provided in an image processing circuit of an example.

FIG. 2 is a flowchart showing the basic flow of a sign extension of the example.

FIG. 3 is a schematic diagram showing a focused pixel and referenced pixels for the sign extension of the example.

FIG. 4 is a block diagram conceptually showing the configuration of the computing unit provided in the image processing circuit of a modified example.

FIG. 5 is a flowchart showing the flow of sign extension of the modified example.

FIG. 6 is a schematic diagram showing a focused pixel and referenced pixels for the sign extension of the modified example.

FIG. 7 is a schematic diagram showing a focused pixel and referenced pixels for the sign extension of the modified example.

FIG. 8 is a block diagram conceptually showing the configuration of the computing unit provided in an image processing circuit of a second modified example.

FIG. 9 is a flowchart showing the basic flow of a sign extension of the second modified example.

FIG. 10 is a block diagram conceptually showing the configuration of the computing unit provided in an image processing circuit of a second modified example.

FIG. 11 is a schematic diagram showing a focused pixel and referenced pixels for the sign extension of the second modified example.

FIG. 12 is a block diagram conceptually showing the configuration of the computing unit provided in an image processing circuit of a third modified example.

FIG. 13 is a block diagram conceptually showing the configuration of the image processing circuit of a third modified example.

FIG. 14 is a block diagram conceptually showing the configuration of an information reproducing apparatus of a example.

### DESCRIPTION OF REFERENCE CODES

10, 13 video data
11 line memory
12 sign extension unit
14 multi-component sign extension unit
100, 200, 300, 400 difference value calculating and adjusting part
110, 210, 310, 410 valid pixel counter
120, 220, 320, 420 smoothness adjusting part
130, 230, 330, 430 prominent point and edge judging part

### BEST MODE FOR CARRYING OUT THE INVENTION

Hereafter, as the best mode for carrying out the present invention, the image processing circuit, the information reproducing apparatus the image processing method and the computer program of the present invention will be explained.

### The Embodiment of the Image Processing Circuit

An embodiment of the image processing circuit of the present invention is provided with: a difference calculating device for calculating difference value between a pixel level of a focused pixel and a pixel level of a referenced pixel; a first comparing device for comparing the difference value with a first threshold; a counting device for judging the referenced pixel that the difference value is less than or equal to a predetermined threshold to be a valid pixel, and counting the number of the valid pixels; a second comparing device for comparing the number of the valid pixels with a second threshold; and a correcting device for correcting the pixel level of the focused pixel, in case that the number of the valid pixels is more than or equal to a second threshold.

According to the embodiment of the image processing circuit of the present invention, first of all, the difference value between the pixel level of the focused pixel that is a target of the bit expansion process and the pixel level of the referenced pixel located surrounding the focused pixel, by the operation of the difference calculating device. The pixel level indicates one or all of elements relating to brightness and color of pixel, such as so-called brightness or color difference or the like. Moreover, the difference value of the pixel level typically indicates, the difference of value of the pixel level between each pixel. For example, when using brightness as one example of the pixel level, the pixel level means the difference of the brightness between each pixel. When using color difference as one example of the pixel level, the pixel level means the difference of the color difference between each pixel. As illustrated above, the difference value means the difference between equivalent value of each pixel.

Moreover, the referenced pixel in this embodiment typically indicates pixels located adjacent to the focused pixel. However, the construction may be acceptable that, pixels located in a predetermined are close to the focused pixel (for example, pixels located in area with 3×3 or 5×5 pixels centering around the focused pixel) may be handled as the referenced pixels by being selected especially, as described below.

Next, a difference value of the pixel level of the focused pixel and one of the referenced pixels is compared by the operation of the first comparing device. In this time, if the difference value of the pixel level of the focused pixel and the referenced pixel in a range determined based on the first threshold, the referenced pixel is judged to be a valid pixel for the subsequent sign extension. Thus, the pixel level of the referenced pixel used in the sign extension is limited by the difference from the pixel level of the focused pixel.

Afterwards, the number of the referenced pixels judged to be the valid pixels is counted by operating of the counting device. And, the counted number of the valid pixels is compared with the predetermined second threshold by the second comparing device. At this time, if the number of the valid pixels is more than or equal to the second threshold, it is judged that the pixel level between the focused pixel and the referenced pixels as to be smooth and the sign extension can be preferably performed. In this embodiment, the above-mentioned number of the valid pixels counted is handled as an indicator of smoothness of the pixel level of pixels located adjacent to the focused pixel. In this embodiment, the pixel level judged to be smooth indicates that pixels with pixel level different from others greatly, such as edges and prominent points do not exist more than a constant amount, in the area where pixels adjacent to the focused pixel located.

And, if the pixel level between the focused pixel and the referenced pixels judged to be smooth, the pixel level of the focused pixel before the quantization is presumed by the correction device, and the sign extension (in other words, a correction process) is performed.

By virtue of such construction, the sign extension for bringing information compressed by using image compressing technology such as a digital image close to the gray scale expression with different number of bits originally used to be before performing quantization, can typically be performed.

Moreover, in this embodiment, especially, the sign extension during excluding pixels with pixel level greatly different from adjacent pixels, such as pixels in the edge portions or prominent points by limiting the difference value between the focused pixel with respect to each of the referenced pixels can be performed.

According to this embodiment, the sign extension explained below in detail is performed with respect to the focused pixel, only if pixel level of pixels located adjacent to the focused pixel is judged to be smooth. By this, blurring or the like that appears in the image after performing the sign extension caused by the edge portion or the prominent points can be prevented.

As explained above, according to the image processing circuit of this embodiment, the sign extension for bringing images close to the gray scale of the original image before the quantization can be performed.

Incidentally, in this embodiment, the first threshold and the second threshold may be determined properly preliminarily, in the simulation, the experiment or the like and also depending on the predetermined condition (such as the distance of the referenced pixel from the focused pixel).

In one aspect of the image processing circuit of the present invention, the correction device corrects the pixel level of the focused pixel by adding the value which is calculated by dividing the sum of the difference value between the pixel level of the focused pixel and the pixel level of the valid pixel by a predetermined value, to the pixel level of the focused pixel.

According to this aspect, sign extension is performed by being calculated the sum of the difference value between the pixel levels of the focused pixel and the referenced pixel judged to be valid pixels, and being added the sum of the difference values to the divided by the predetermined value, to the pixel level of the focused pixel.

Incidentally, the predetermined value may typically be a value that is configured before at least the process is performed, or the value configured during the operation of the image processing circuit.

By virtue of such construction, the sign extension for bringing images close to the gray scale of the original image before the quantization can preferably be performed.

In the aspect such that the correction device corrects the pixel level of the focused pixel by adding the value which is calculated by dividing the sum of the difference value between the pixel level of the focused pixel and the pixel level of the valid pixel by a predetermined value, to the pixel level of the focused pixel described above, the correcting device may determine the predetermined value by multiplying the number of the valid pixels by a predetermined coefficient value.

By virtue of such construction, the predetermined value that varies dynamically depending on the number of the valid pixels judged, can be acquired by the operation of the correcting device. By using such the predetermined value, the correction of the pixel level of the focused pixel in view of the number of the valid pixels can be performed. Therefore, the sign extension for bringing images close to the gray scale of the original image before the quantization can preferably be performed.

In another aspect of the image processing circuit of the present invention, the image processing circuit is further provided with a third comparing device for comparing an absolute value of a maximum difference value which is the difference value between the pixel level of the focused pixel and the pixel level of the referenced pixel that the absolute value of the different value becomes the maximum, with a third threshold, and a prominent point judging device for judging the referenced pixel that the absolute value of the maximum difference value is more than or equal to the third threshold, as a prominent point, and the correcting device does not perform correction of the pixel level of the focused pixel in case that one of the referenced pixels is judged to be the prominent point.

By virtue of such construction, the sign extension is not performed on the focused pixel, in case that the pixel that the pixel level is greatly different from the focused pixel (in other words, the difference value of the pixel level is more than or equal to the third threshold) is detected among the focused pixel.

It is highly possible that the pixel that the pixel level is greatly different from a focused pixel is a pixel that typically is in a so-called prominent point, the edge portion, or the like in the image. Therefore, by performing the sign extension in pixel area located adjacent to the focused pixel, the prominent point and the edge portion may be buried (In other words, become unremarkable).

Then, by virtue of such construction, even in the case that the pixel located adjacent to the focused pixel is the prominent point, the prominent point is prevented being buried caused by processing the focused pixel with pixel that is adjacent to the focused pixel and the prominent point and the edge portion in the image can be preserved suitably.

In another aspect of the image processing circuit of the present invention, the image processing circuit is further provided with a pixel selecting device for selecting the referenced pixel from pixels located adjacent to the focused pixel.

By virtue of such construction, the sign extension can preferably be performed during being selected appropriate pixels located adjacent to the focused pixel as referenced pixels.

The pixel selecting device may be configured to select eight pixels within the range of 3×3 of the focused pixel (in other words, located directly adjacent to the focused pixel) as the referenced pixels, for instance, or may be configured to select the pixel within other ranges such as 5×5 and 3×5 as the referenced pixels.

Moreover, for example, the pixel selecting device may be configured to select pixels located around the focused pixel by separating two or more ranges corresponding to the distance from the focused pixel. Specifically, the pixel selecting device of this configuration selects pixels within the range of 3×3 of the focused pixel as a first range, and sixteen pixels located adjacent to the pixels of the first range (in other words, located around the outer edge of the range of 5×5 of the focused pixel) as a second range. At this time, by determining a threshold for comparing of the difference value, a threshold of the number of the valid pixels for judgment of smoothness, and the predetermined value for dividing the sum of the difference values (in other words, a coefficient value for adopting to a value that is added to the pixel level of the focused pixel) separately for each range, on the the correction process according to the distance from the focused pixel to each of the referenced pixels can be performed.

By virtue of such construction, a pixel located around the focused pixel, with the pixel level close to the pixel level of the focused pixel can be suitably selected, and the sign extension mentioned above can be performed on the selected pixel. Therefore, the sign extension based on more appropriate referenced pixels can be performed, and the improvement of the accuracy of the sign extension can be achieved.

In the aspect that the image processing circuit is provided with the pixel selecting device mentioned above, the pixel selecting device selects the referenced pixel from pixels located adjacent to the focused pixel based on at least one of the comparison of the difference values performed by the first comparing device or the comparison of the number of the valid pixels performed by the second comparing device.

According to this aspect, the sign extension that makes more or more appropriate pixels as the referenced pixel can be performed, by further selecting the referenced pixel based on the judgment result such as smoothness of the pixel level of the referenced pixel, for instance.

According to this aspect, when the pixel level of the referenced pixel located adjacent to the focused pixel judged to be very smooth for instance, it is highly possible that the pixel level of pixels located around further outer of the focused pixel becomes also smooth. Therefore, such pixels are selected as a referenced pixel, and the comparison of the difference value and the judgment of the smoothness is performed.

In this time, it may be configured to expand the referenced pixel gradually such that pixels firstly selected as the referenced pixels classified as the first range, and surrounding pixels further selected depending on the smoothness of the pixel level of the first range classified as the second range.

By virtue of such construction, in case that the pixel level of the referenced pixel in the range relatively closer to the focused pixel is smooth, pixels located around the referenced pixels that the pixel level supposed to be smooth, too can be used for the sign extension, as further referenced pixels. Therefore, Therefore, the sign extension based on more appropriate referenced pixels can be performed, and the improvement of the accuracy of the sign extension can be achieved.

Moreover, in case that a pixel that great difference in the pixel level is seen is found by the judgment of the different value or the smoothness, it may be constructed not to select pixels in the direction of the pixel found further as referenced pixels. Moreover, it may be constructed to select pixels in the direction differs from the direction of the pixel found as referenced pixels.

In other words, in case that the great difference in the pixel level is seen in a pixel, because the pixel is supposed to be an edge portion in the image or the like, pixel in the direction of the pixel supposed to be have the pixel level greatly different from the pixel level of the focused pixel. Therefore, the possibility to select the reference pixel with the smooth pixel level preferably by avoiding the edge portion is increased, by selecting further reference pixels while avoiding the direction of such pixel.

Moreover, it may be constructed to judge whether the reference pixel is in the edge portion or not by subdividing conditions such that all of the difference value of the pixel level of referenced pixels located adjacent to the focused pixel is high. For example, in case that a pixel with the high difference value of the pixel level is detected among referenced pixels, only the pixel is supposed to have pixel level different from others because of some cause, other than the pixel is in the edge portion. Therefore, in case that the high difference value is detected not only in the pixel but also in pixels neighboring each other, by judging a cluster of the pixels as in the edge portion, the improvement of the accuracy of the judgment of the edge portion can be achieved.

In another aspect of the image processing circuit of the present invention, the pixel selecting device weights each of the referenced pixels depending on the distance from the focused pixel, and at least one of (i) the comparison of the difference values performed by the first comparing device, (ii) the comparison of the number of the valid pixels performed by the second comparing device and (iii) the addition of the sum of the difference value to the pixel level of the focused pixel, is performed depending on the weighting.

According to this aspect, degree of influence of the pixel level of a valid pixel is regulated depending on the distance from the focused pixel. Typically, the influence of the pixel level of the referenced pixel farther away from the focused pixel on the sign extension becomes smaller.

Therefore, by weighting on the judgment whether a referenced pixel is a valid pixel or not, and the judgment whether the pixel level of pixels in the prescribed area is smooth or not, it is possible that degree of influence of the pixel level of each of the referenced pixels on the sign extension is preferably regulated.

For example, the degree of influence of the referenced pixel used for the sign extension can be preferably regulated by changing the first threshold that is compared with the difference values of the pixel level used in judgment whether a referenced pixel is a valid pixel or not, depending on the distance from the focused pixel.

Moreover, regarding to the referenced pixels in prescribed ranges, the degree of influence can preferably be regulated with respect to each range of the referenced pixels used for the sign extension, by changing the second threshold that is compared with the number of the valid pixels used in judgment whether the pixel level of the referenced pixels in the range is smooth or not.

Furthermore, the degree of influence of the referenced pixel used for the sign extension can be preferably regulated by multiplying the correction value used for the sign extension with coefficient values differently depending on the range in which the correction value is calculated.

As explained above, according to this aspect, the sign extension can be performed while the degree of influence of each pixel is preferably regulated by acquiring valid pixels used for the sign extension or changing the correction value depending on the distance from the focused pixel to the referenced pixel.

### The Embodiment of the Information Reproducing Apparatus

The embodiment of the information reproducing apparatus of the present invention is provided with the embodiment of the image processing circuit of the present invention (however, various aspects are included) mentioned above.

According to the embodiment of the information reproducing apparatus of the present invention, the reproduction of the data preferably performed, while achieving the effect similar to various effects that can be achieved by the embodiment of the image processing circuit of the present invention mentioned above.

### The Embodiment of the Computer Program

The embodiment of the computer program of the present invention is a computer program for controlling a computer provided in the embodiment of information reproducing apparatus mentioned above (however, various aspects are included), and makes the computer at least one portion of the difference calculation device, the first comparing device, the counting device, the second comparing device and the correction device.

According to the embodiment of the computer program of the present invention, the reproduction of the data while achieving the effect similar to various effects that can be achieved by the embodiment of the image processing circuit of the present invention mentioned above can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the embodiment of the image processing circuit of the present invention, the embodiment of the computer program of the present invention can also adopt various aspects.

### The Embodiment of the Computer Program Product

The embodiment of the computer program product of the present invention is a computer program product in a computer-readable medium for tangibly embodying a program of instructions executable by a computer provided in the embodiment of information reproducing apparatus mentioned above (however, various aspects are included), and makes the computer at least one portion of the difference calculation device, the first comparing device, the counting device, the second comparing device and the correction device.

According to the embodiment of the computer program product of the present invention, the aforementioned embodiment of the information reproducing apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disc or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the information reproducing apparatus of the present invention.

Incidentally, in response to the various aspects of the embodiment of the information reproducing apparatus of the present invention, the embodiment of the computer program product of the present invention can also adopt various aspects.

### The Embodiment of the Image Processing Method

The embodiment of the image processing method is an image processing method provide with: a difference calculating process of calculating difference value between a pixel level of a focused pixel and a pixel level of a referenced pixel; a first comparing process of comparing the difference value with a first threshold; a counting process of judging the referenced pixel that the difference value is less than or equal to a predetermined threshold to be a valid pixel, and counting the number of the valid pixels; a second comparing process of comparing the number of the valid pixels with a second threshold; and a correcting process of correcting the pixel level of the focused pixel, in case that the number of the valid pixels is more than or equal to a second threshold

According to the embodiment of the image processing method of the present invention, the reproduction of the video data can be performed, while achieving the effect similar to various effects that can be achieved by the embodiment of the image processing circuit of the invention mentioned above.

Incidentally, in response to the various aspects of the embodiment of the image processing circuit of the present invention, the embodiment of the image processing method of the present invention can also adopt various aspects.

As explained above, the image processing circuit in the embodiment is provided with the difference calculating device, the first comparing device, the counting device, the second comparing device and the correcting device. The information reproducing apparatus is provided with the image processing circuit in the embodiment mentioned above. The computer program in the embodiment makes a computer function as the information reproducing apparatus in the embodiment mentioned above. The image processing method in the embodiment is provided with the difference calculating process, the first comparing process, the counting process, the second comparing process and the correcting process.

Therefore, it is possible to perform preferable sign extension on the compressed image data or the like, and to record and reproduce information while bringing images close to the image quality of the original image before the compression.

### EXAMPLE

Hereinafter, a best mode for carrying out the present invention will be explained with reference to the drawings.

### (1) The Basic Structure Example

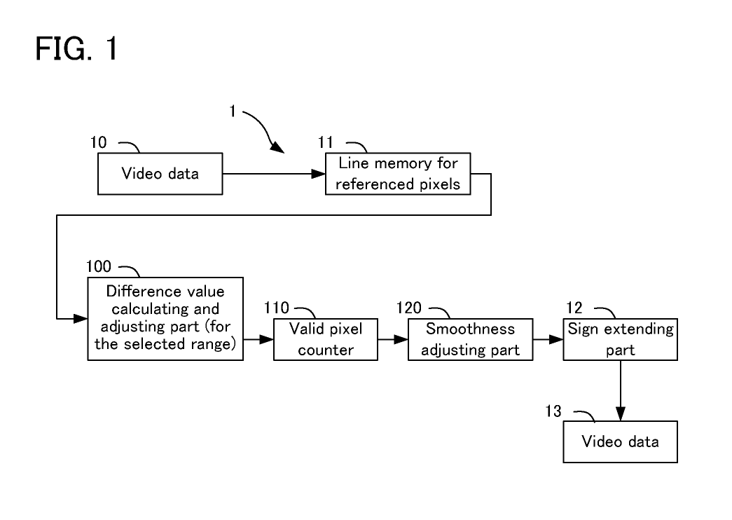

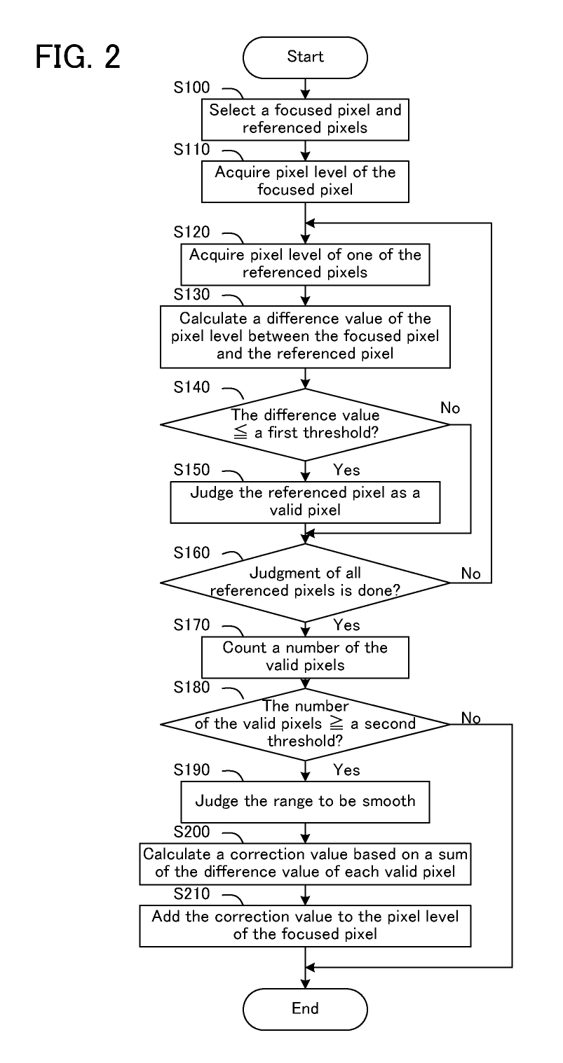

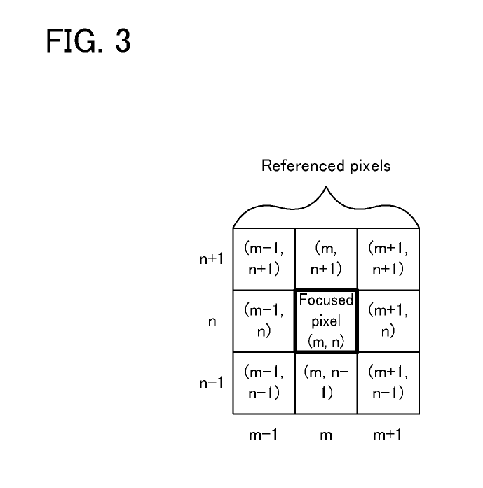

At first, basic structure example of a computing unit of an image processing circuit 1 in an example of the present invention will be explained with reference to FIG. 1 to FIG. 3. FIG. 1 is a block diagram conceptually showing the configuration of the computing unit provided in an image processing circuit of an example. FIG. 2 is a flowchart showing the basic flow of a sign extension of the example. FIG. 3 is a schematic diagram showing a focused pixel and referenced pixels for the sign extension of the example.

The image processing circuit 1 in the basic structure example is typically provided on the apparatus for recording or reproducing digital video data such that a DVD recorder, a DVD player, a Blu-ray recorder, a Blu-Ray player and a television for digital broadcasting. The image processing circuit 1 in the basic structure example is the structure that output video data brought close to the gray scale used before the quantization by the image compression, by receiving such video data and correcting the pixel level such that brightness or color difference of each pixel of the video data.

The basic structure and the operation of the image processing circuit 1 in the basic structure example is explained as follows, with reference to a block diagram of FIG. 1 and a flowchart of FIG. 2.

As shown in FIG. 1, the image processing circuit 1 of the basic structure example is constructed that video data 10 is input into a line memory 11. The line memory 11 is constructed so as to receive an input of information such as location information, pixel level and the like about a focused pixel that the sign extension is performed on and each of referenced pixels selected from pixels in the certain range around the focused pixel, and store it. In other words, the focused pixel and the referenced pixels of the basic structure example are selected by being input information relating a certain pixel (step S100).

FIG. 3 is one example of a schematic diagram showing a focused pixel and referenced pixels for the sign extension of the example. In the example, eight pixels located within the range of 3×3 pixels from coordinates (m−1, n−1) to coordinates (m+1, n+1) centering on (in other words, located adjacent) the focused pixel located at the position of coordinates (m, n), are selected as referenced pixels.

The basic structure and the operation of the image processing circuit 1 in the basic structure example is explained continuously, with reference to a block diagram of FIG. 1 and a flowchart of FIG. 2.

In a difference value calculating and adjusting parts 100, the pixel level with respect to each pixel is acquired, the difference value between the pixel level of each of the referenced pixel within the range and the pixel level of the focused pixel is calculated, and the difference value respectively of the referenced pixel is judged.

More specifically, after the pixel level of the focused pixel is acquired (step S110), the pixel level of one referenced pixel among the referenced pixels in the range is acquired (step S120), and the difference value between the focused pixel and the referenced pixel is calculated by subtracting one from the other, for instance (step S130).

Next, the difference value of the pixel level regarding to the referenced pixel and a predetermined threshold (in other words, a first threshold) are compared (step S140). At this time, in case that the difference value is less than or equal to the first threshold (step S140:Yes), the corresponding referenced pixel is judged to be a valid pixel (step S150). Moreover, the signal that shows that the referenced pixel is judged to be a valid pixel is transmitted to a valid pixel counter 120.

Moreover, in case that the difference value is more than the first threshold (step S140:No), the corresponding referenced pixel is not judged to be valid pixel.

The judgment whether the referenced pixel is a valid pixel or not explained above is performed on each pixel selected as the referenced pixel within the range respectively.

And, when the judgment regarding all of the referenced pixels within the range whether it is the valid pixel or not is finished (step S160:Yes), a number of pixels judged to be the valid pixel among the referenced pixels within the range is counted according to the data stored in the valid pixel counter 120 (step S170). At this time, data that shows the number of the valid pixels counted is input into a smoothness adjusting part 120.

Next, the number of the valid pixels is compared with a second threshold by operation of the smoothness adjusting part 120 (step S180). And then, in case that the number of the valid pixels is more than or equal to the second threshold (step S180:Yes), the pixel level of the focused pixel and the referenced pixels within the range is judged to be smooth (step S190).

The pixel level being smooth typically means that the pixel level of the focused pixel and the referenced pixel located around the focused pixel is similar. In other words, smoothness adjusting part 120 uses the number of the valid pixels as an index that shows smooth in a pixel a focused pixel peripheral of the pixel level.

The second threshold means a lower limit of the number of valid pixels required for being judged pixels within the range of 3×3 of the focused pixel among the eight referenced pixels shown in FIG. 3 as smooth. Such the second threshold may be decided and configured by an experiment, an simulation or the like.

In case that the referenced pixel in the range is judged to be smooth (step S190), data such as the pixel level regarding pixels judged to be the valid pixels are input into the sign extending part 12, and are used for the sign extension of the focused pixel. On the other hand, the referenced pixels not judged to be the valid pixels are not used for the sign extension. More specifically, the difference values of the pixel level between the focused pixel and each of the valid pixels are added each other, and the sum of the difference value is calculated, by operation of the sign extending part 12 that receives input of the data. And, the correction value for the sign extension is calculated by being divided sum of the difference values by a predetermined value (step S200). Next, the sign extension of the focused pixel is performed by adding the correction value to the pixel level of the focused pixel (step S210).

And, video data 13 including the focused pixel that the sign extension have been performed on are output, then a series of process of sign extension is finished.

As explained above, according to the image processing circuit of the example, the sign extension using pixels that the difference of the pixel level from the focused pixel is relatively smaller is performed, by referencing the pixels level of pixels located around the focused pixel. Moreover, the sign extension is performed on the range of the referenced pixels located around the focused pixel, in case that, the pixel level of the range is judged to be smooth, in the judgment of smoothness of the pixel level based on the number of pixels judged to be the valid pixels. Therefore, the sign extension can be performed while avoiding the situation such that the blurring is appeared in the image caused by the sign extension is performed by using pixels that the pixel level is greatly different from the focused pixel such as pixels in the edge portion, the prominent point or the like in the vide data, for instance.

The pixel level in the sign extension explained above means each element such as the brightness (such as Y0 and Y1) and the color differences (such as CB, CR) or all the elements collectively. Therefore, the sign extension explained above may be performed for one of the elements of the pixel level, and may be performed for a number of the elements individually.

Moreover, the predetermined value mentioned above may be a number calculated by multiplying the number of the valid pixels by a predetermined coefficient value, as one example. In other words, the predetermined value may be determined during the operation of the image processing circuit 1. On the other hand, the predetermined value may be determined preliminarily in the simulation, the experiment or the like.

In the basic structure example explained above, eight pixels within the range of 3×3 of the focused pixel is selected as the referenced pixels, however the referenced pixels may be selected by other modes. For instance, pixels within the ranges of 5×5 and 3×5 of the focused pixel may be selected as the referenced pixels, or may be selected by any other method.

### (2) Modified Example

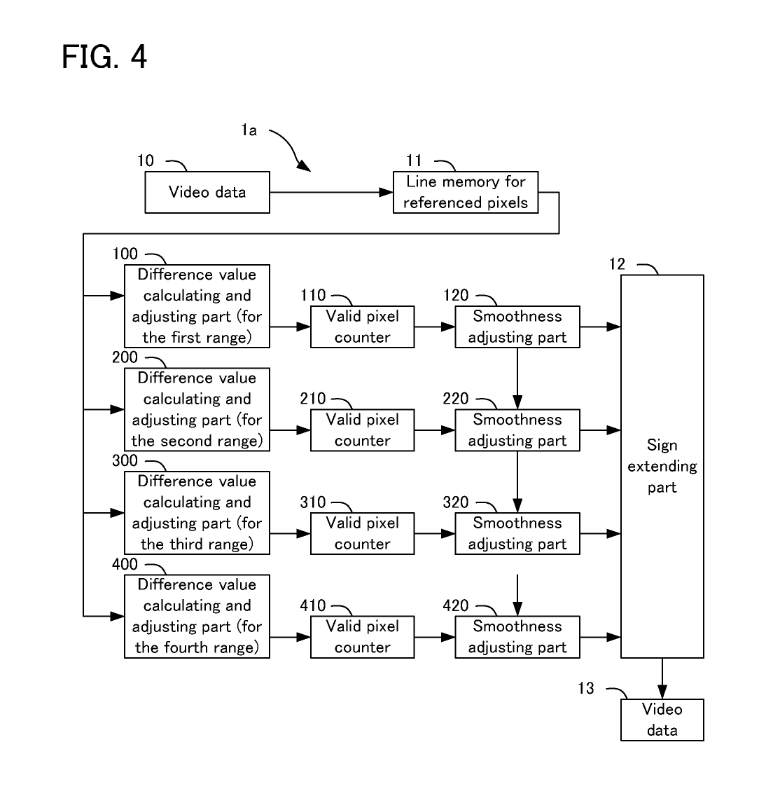

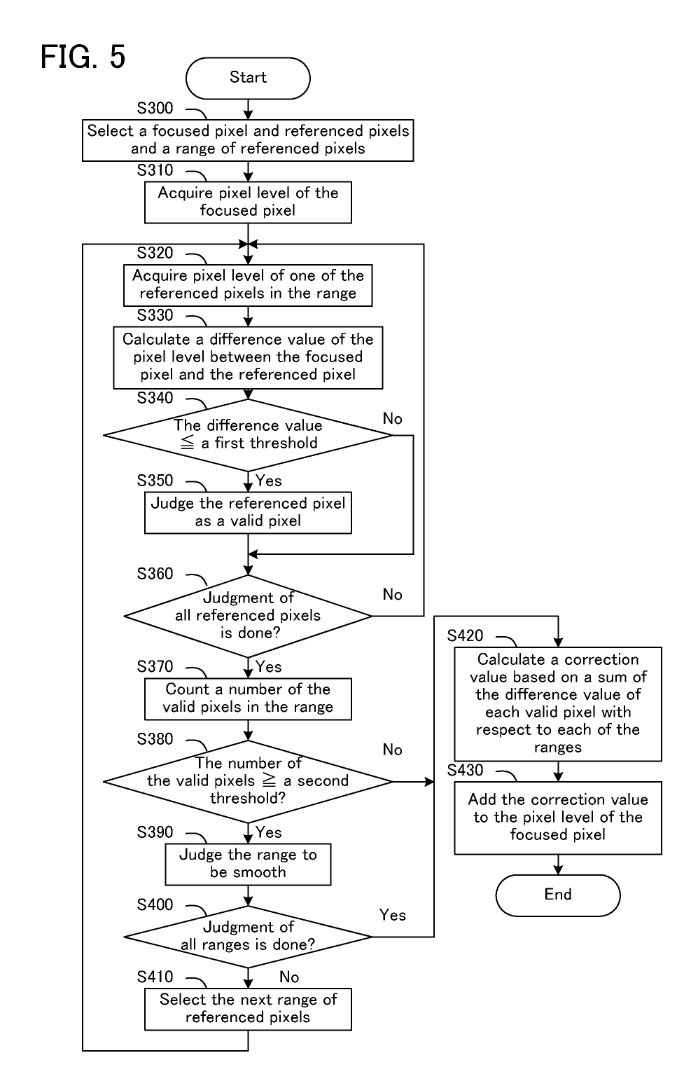

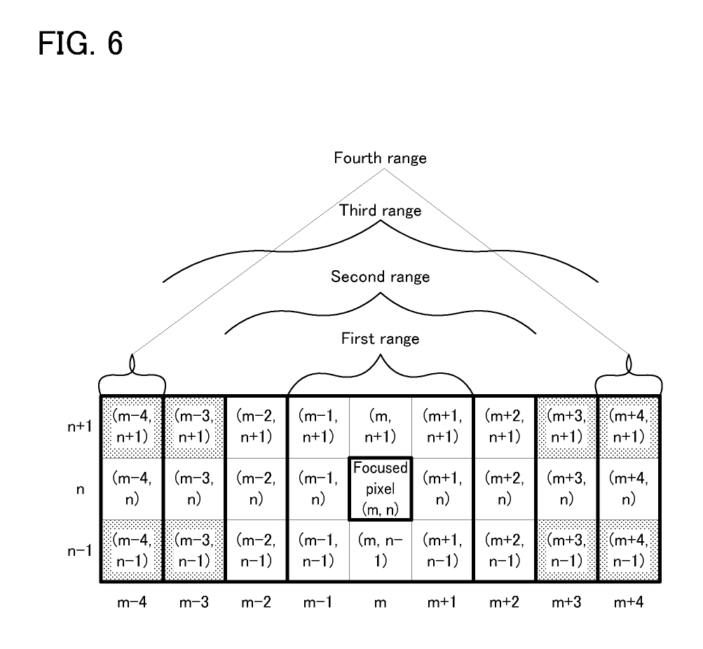

Next, a modified example of the image processing circuit 1 relating to the present invention will be explained with reference to FIG. 4 to FIG. 6. FIG. 4 is a block diagram conceptually showing the configuration of the computing unit provided in the image processing circuit of the modified example. FIG. 5 is a flowchart showing the flow of sign extension of the modified example. FIG. 6 is a schematic diagram showing the focused pixel and the referenced pixels for the sign extension of the modified example.

Incidentally, the same constituents as those shown in the other drawings carry the same numerical references.

According to the operation of the image processing circuit 1a of the modified example, pixels located around the focused pixel is classified based on the distance from the focused pixel or the like into a number of ranges (such as a first range or a second range), and the smoothness of pixels in each range is judged respectively. And, the sign extension that uses the pixel level of the valid pixels included within the range judged to be smooth is performed.

A basic structure and an operation of the image processing circuit 1a of the modified example is explained as follows, with reference to a block diagram of FIG. 4 and a flowchart of FIG. 5.

As shown in FIG. 4, the image processing circuit 1a of the modified example is constructed so as to receives the video data 10, and then data including location information and the pixel level about the focused pixel and the pixels selected as the referenced pixels are input into a line memory 11.

At this time, the referenced pixel is classified into a number of ranges such as a first range to a fourth range, depending on the distance from the focused pixel.

FIG. 6 is one example of pattern diagrams that show locational relation between the focused pixel and the referenced pixels in the modified example. In the example, eight pixels located within the range of 3×3 pixels from coordinates (m−1, n−1) to coordinates (m+1, n+1) centering on (in other words, located adjacent) the focused pixel located at the position of coordinates (m, n), are selected as referenced pixels in the first range. And, six pixels which are located within the range of 5×3 pixels from coordinates (m−2, n−1) to coordinates (m+2, n+1) and are not the focused pixel or in the first range are selected as referenced pixels in the second range. And, two pixels which are located within the range of 7×3 pixels from coordinates (m−3, n−1) to coordinates (m+3, n+1) and are not the focused pixel or in the first range or the second range, shown in the white square in the drawings are selected as referenced pixels in the third range. And, two pixels which are located within the range of 9×3 pixels from coordinates (m−4,n−1) to coordinates (m+4, n+1) and are not the focused pixel or in the first to third range, shown in the white square in the drawings are selected as referenced pixels in the fourth range.

In the modified example, the judgment of smoothness of the pixel level is performed on the referenced pixels classified into each of the ranges sequentially, typically from the referenced pixels within the closer range. The basic structure and the operation of the image processing circuit 1a in the modified example is explained continuously, with reference to FIG. 4 and FIG. 5.

At first, the judgment on whether the valid pixels or not is performed by the difference value calculating and adjusting parts 100 with respect to the referenced pixels in the first range, by being received the pixel level, being calculated the difference value of the pixel level between each of the referenced pixels in the range and the focused pixel, and being compared the difference value with the first threshold, as well as the basic structure example (step S320 to step S350).

And, when the judgment regarding all of the referenced pixels within the first range whether it is the valid pixel or not is finished (step S360:Yes), a number of pixels judged to be the valid pixels among the referenced pixels within the first range is counted according to the data stored in the valid pixel counter 120 (step S370). Then, by the operation of the smoothness adjusting part 120, the judgment on whether the pixel level of the referenced pixels in the first range is smooth or not (step S380 and step S390).

At this time, in case that the pixel level of the referenced pixels in the first range is judged to be smooth, the judgment on whether the pixel level is smooth or not is performed with respect to the referenced pixels in the second range as well as the judgment with respect to the referenced pixels in the first range (step S320 to step S390).

In case that the pixel level of the referenced pixels in the second range is judged to be smooth, the judgment on whether the pixel level is smooth or not is performed with respect to the referenced pixels in the third range as well as the judgment with respect to the referenced pixels in the first range (step S320 to step S390).

In case that the pixel level of the referenced pixels in the third range is judged to be smooth, the judgment on whether the pixel level is smooth or not is performed with respect to the referenced pixels in the fourth range as well as the judgment with respect to the referenced pixels in the first range (step S320 to step S390).

And, after the judgment whether the pixel level is smooth or not is performed with respect to all the ranges including pixels selected as the referenced pixels (step S400:Yes), the sign extension is performed by being calculated the correction value for each range respectively, and being added the correction value to the pixel level of the focused pixel (step S420 and step S430).

More specifically, the difference values of the pixel level between the focused pixel and each of the referenced pixels judged to be the valid pixels in the first range are added each other. And, by being divided the sum of the difference values by the predetermined value, the correction value for the sign extension is calculated. Moreover, the correction values are also calculated with respect to the second range, the third range and the fourth range by using the pixel level of each range respectively, in the same manner (step S420).

Next, the sign extension of the focused pixel is performed by adding the correction value of each range to the pixel level of the focused pixel (step S430).

And, video data 13 including the focused pixel that the sign extension have been performed on are output, then a series of process of sign extension is finished.

The whether the pixel is valid or not and the judgment whether the pixel level is smooth or not is performed on each of the first to fourth ranges using one and the same series of thresholds (such as the first threshold and the second threshold), in the modified example explained above. However, it may be constructed so that these judgments are performed using a number of different thresholds with respect to each range.

For instance, the judgments mentioned above is performed by using the first threshold and the second threshold different from values for the judgments on the first range with respect to the second range where the degree of influence of the pixel level to the focused pixel is regarded as relatively lower than the first range which locates closer to the focused pixel. Similarly, the judgments may be performed with respect to the third and fourth ranges by using further different thresholds. In other words, it may be constructed to use data by weighting based on the range of the referenced values classified by the distance from the focused pixel.

Similarly, a correction value used for the sign extension may be weighted for pixels in each range respectively typically based on the distance from the focused pixel, by varying the predetermined value for dividing the sum of the difference value or using different coefficient value from others upon the correction value. As an example of the predetermined value for dividing the sum of the difference value, it may be constructed that weighting is performed by multiplying coefficient value which varies depending on the distance of the range from the focused pixel or is configured based on each range respectively, on the number of the valid pixels.

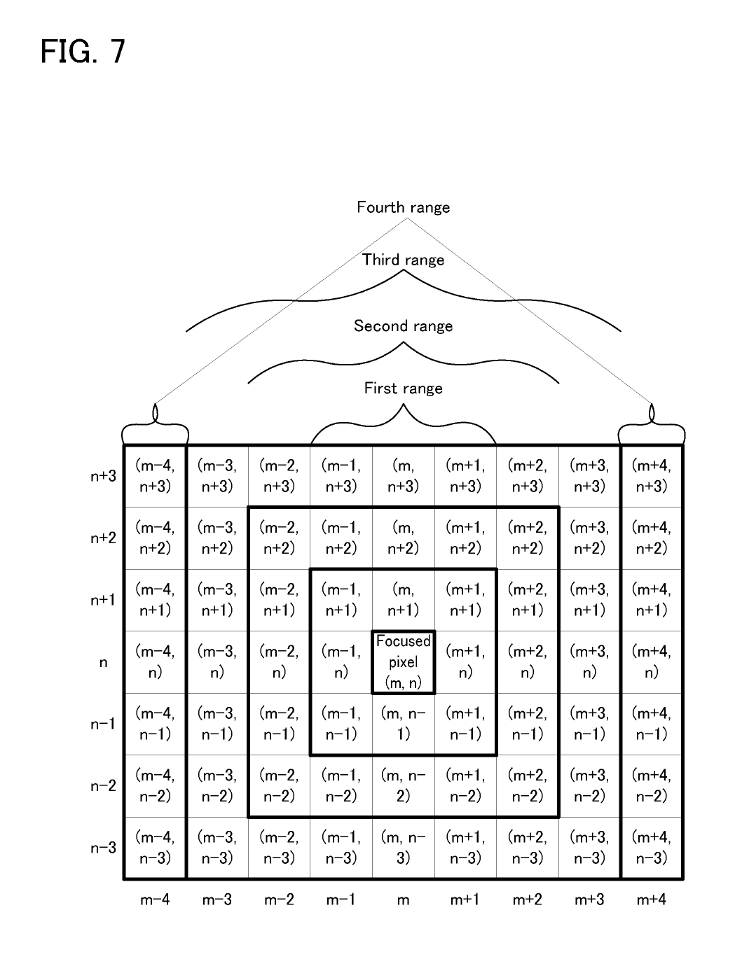

Moreover, the referenced pixel may be selected by other modes though the referenced pixel within each range has been selected as shown in FIG. 6 in the modified example explained above. For instance, each ranges may be configured so as to contain more pixels as shown in FIG. 7.

In the modified example explained above, the referenced pixels are classified into four ranges such as the first range to the fourth range, however, the referenced pixels may be classified by other method, for example, classified into three or five ranges.

In the modified example explained above, when the first range is judged to be smooth, judgment on whether the valid pixels or not is performed with respect to the referenced pixels in the second range which are preliminary selected. However, it may be constructed that the selection of the referenced pixels to be in the second range depending on the result of the judgment regarding smoothness with respect to the pixels in the first range or the like.

As explained above, according to the image processing circuit 1a of the modified example, the sign extension can be performed by referring pixels located further distantly while also achieving the effect of the basic structure example that is achieved the judgment with respect to the pixel level and smoothness of the pixels located adjacent to the focused pixel.

At this time, the referenced pixel is typically classified into a number of ranges depending on the distance from the focused pixel, and the judgment whether the pixel is valid or not and the judgment whether the pixel level is smooth or not is performed with respect to pixels in each range respectively. Moreover, the sign extension can be performed while regulating the degree of influence of each referenced pixel suitably by being weighted based on the distance from the focused pixel, in the process of judgment in each of the ranges and the calculation of the correction value of the focused pixel based the valid pixels.

Incidentally, in the modified example, it may be constructed to be similar to the above-mentioned basic composition example with respect to the part not especially described.

### (3) A Second Modified Example

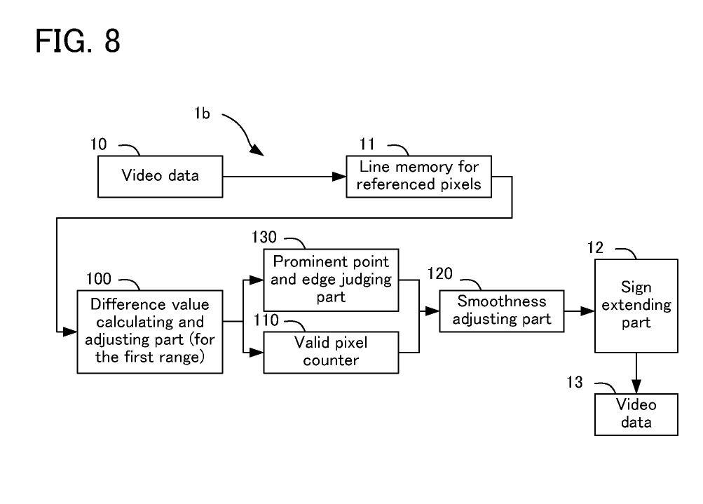

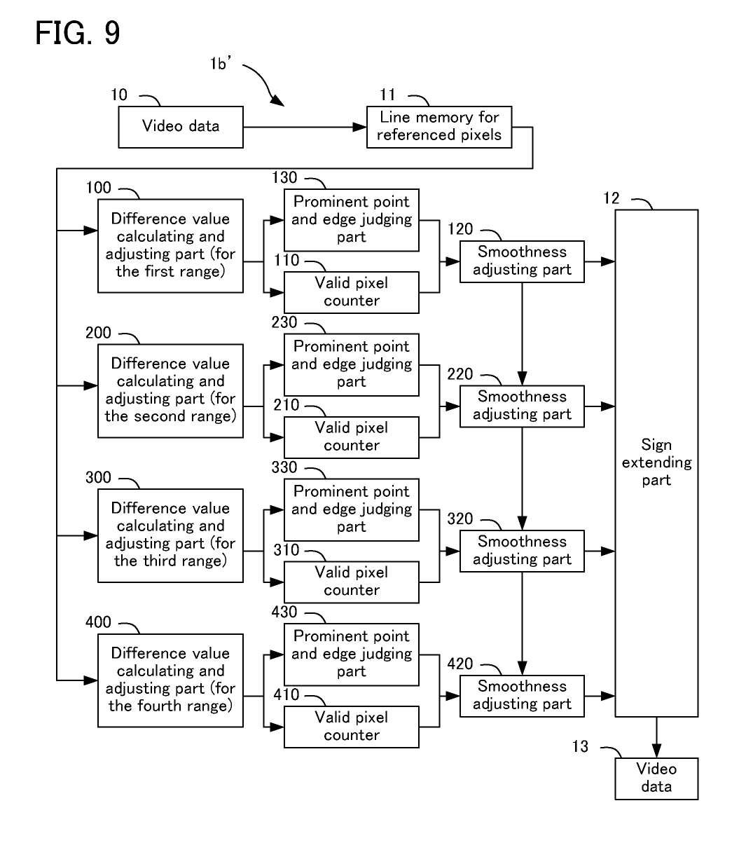

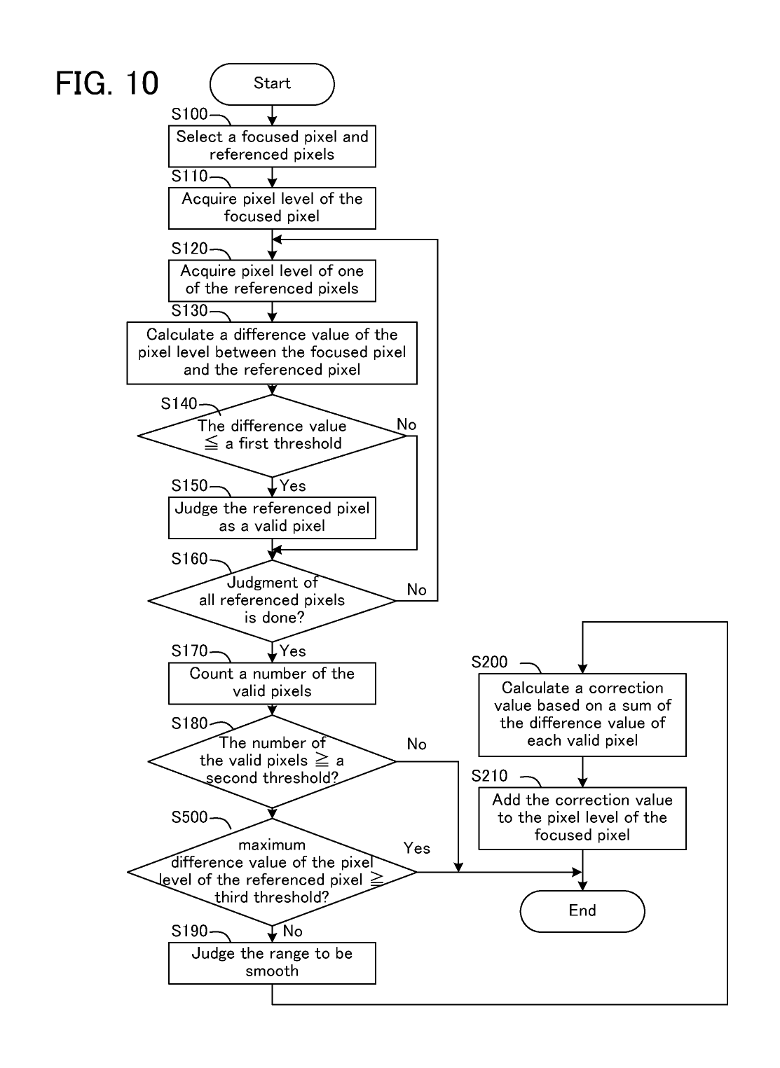

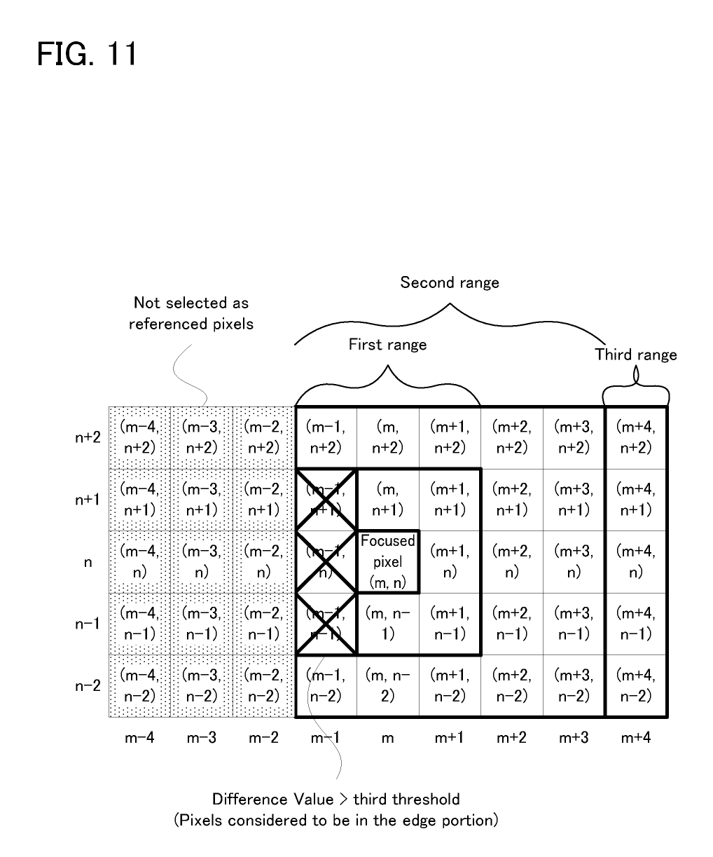

Next, a second modified example of the image processing circuit 1 relating to the present invention will be explained with reference to FIG. 8 to FIG. 11. FIG. 8 and FIG. 9 are block diagrams conceptually showing the configuration of the computing unit provided in the image processing circuit 1b and 1b′ of the second modified example. The image processing circuit 1b illustrated in FIG. 8 shows the structure of the second modified example which is adopted on the image processing circuit 1 shown in the basic structure example (in other words, illustrated in FIG. 1). The image processing circuit 1b′ illustrated in FIG. 9 shows the structure of the second modified example which is adopted on the image processing circuit 1a shown in the modified example (in other words, illustrated in FIG. 4). FIG. 10 is a flowchart showing the basic flow of the sign extension performed by the operation of the image processing circuit 1b of the second modified example. FIG. 11 is a schematic diagram showing the focused pixel and referenced pixels for an edge judgment in the sign extension performed by the operation of the image processing circuit 1b of the second modified example.

Incidentally, the same constituents as those shown in the other drawings carry the same numerical references.

Hereafter, basic operation of the image processing circuit 1b shown in FIG. 8 will be explained with referring to the flowchart of FIG. 10.

According to the operation of the image processing circuit 1b of the second modified example, when a pixel that the pixel level is greatly different from other pixels nearby such as a pixel in an edge portion or prominent point is detected around the focused pixel, it is processed that the sign extension with respect to a pixel close to the pixel (for example, a focused pixel located close to the pixel) is not performed. On the other hand, when the pixel that has such an unusual pixel level is not detected around the focused pixel, the sign extension is performed as mentioned above.

As shown in FIG. 10, in the second modified example, after the number of the valid pixels is compared with the second threshold (step S180) by the operation of the smoothness adjusting part 120 in the same manner as the basic structure example shown in the flowchart of FIG. 2, if the number of the valid pixels counted is more than or equal to the second threshold (step S180:Yes), absolute value of the maximum difference value among the difference value between the pixel level of the focused pixel and the pixel level of the referenced pixel calculated in step S130 mentioned above is compared with the third threshold by the operation of the prominent point and edge judging part 130 (step S500).

And then, if the number of the valid pixels is more than or equal to the second threshold (step S180:Yes) and the absolute value of the maximum difference of the referenced pixels is less than the third threshold (step S500:No), a pixel that the pixel level is greatly different from other pixels nearby such as a pixel in an edge portion or prominent point is assumed not to be detected, and the pixel level of the focused pixel and the referenced pixels in the range is judged to be smooth (step S190).

On the other hand, if the absolute value of the maximum difference of the referenced pixels is more than or equal to the third threshold (step S500:Yes), the edge portion or prominent point is assumed to be detected, and then the sign extension on the focused pixel is not performed. Moreover, when the edge portion or the prominent point is detected in the process with respect to the first range, image processing circuit 1b′ shown in FIG. 9 may be constructed to select the referenced pixel of the second range or subsequent ranges while considering the location of the pixel in the edge portion or prominent point.

In general, when the pixel assumed to be an edge portion or a prominent point is detected in the process with respect to the referenced pixels in the first range, it is highly possible that the referenced pixel in the second range which is adjacent to the pixel assumed to be the edge portion and a prominent point is also a pixel of an edge portion or a prominent point. Therefore, as shown in FIG. 11, the possibility that the valid pixel used for the sign extension of the focused pixel can be selected as much as possible while avoiding an edge portion, a prominent point and the like, by not selecting the referenced pixels in the second range from pixels in the direction of the pixel assumed to be an edge portion and a prominent point, when the pixel assumed to be an edge portion and a prominent point in the first range is detected, and setting the second range in the direction other than the pixel.

In image processing circuit 1b′, when the pixel that the difference value of the pixel level from the focused pixel is larger than that of the third threshold is detected, the selection of the referenced pixel in the following ranges is performed based on the location information of the pixel is considered, by operation of the prominent point and edge judging parts 130 to 430. By the virtue of such construction, the prominent point can be suitably prevented when the pixel located adjacent to the focused pixel is the prominent point that the pixel level is greatly different from that of other adjacent pixels, the prominent point is prevented being buried caused by processing the focused pixel with pixel that is adjacent to the focused pixel and the prominent point. Therefore, the edge portion or the prominent point in the image can be preserved preferably.

Incidentally, in the second modified example, it may be constructed to be similar to the above-mentioned basic composition example with respect to the part not especially described.

### (4) A Third Modified Example

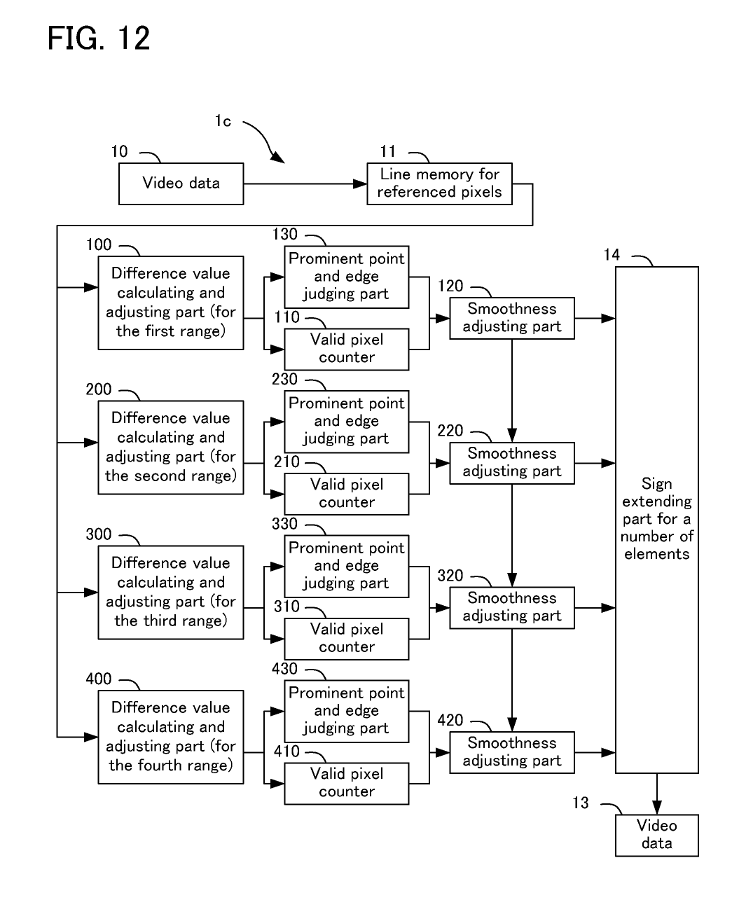

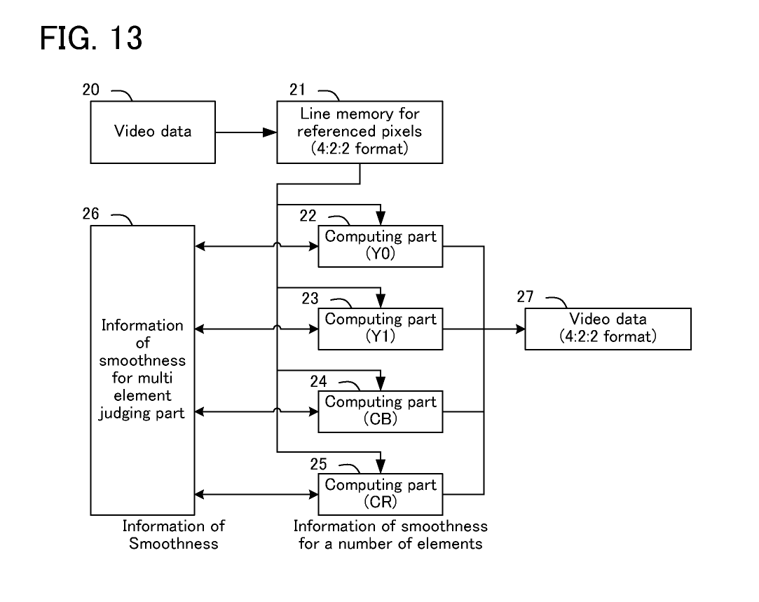

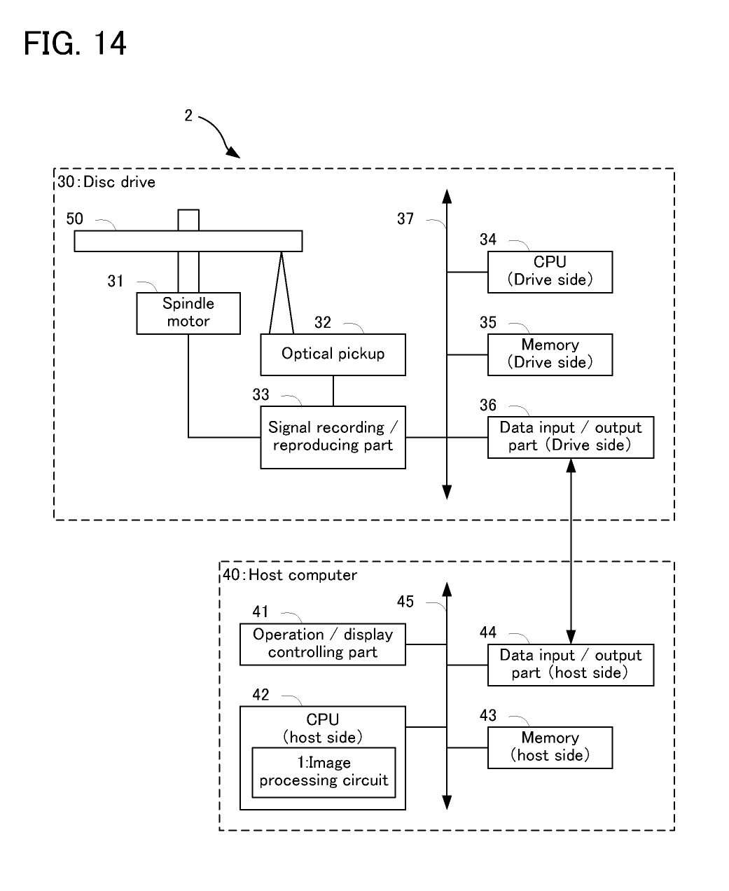

Next, a third modified example of the image processing circuit 1 relating to the present invention will be explained with reference to FIG. 12 and FIG. 13. FIG. 12 is a block diagram conceptually showing the configuration of the computing unit provided in an image processing circuit 1c of the third modified example relating to the present invention. FIG. 14 is a block diagram conceptually showing the configuration of the image processing circuit 1c of the third modified example.

Generally, in digital video data which is recorded in DVDs and Blu-ray discs or used for the digital broadcasting data about brightness in the pixel data is prepared corresponding to each of the pixels respectively, depending on the characteristics of human eyes. On the other hand, the color difference tends to be partly omitted and recorded in 4:2:0 format.

In general, when reproducing such digital video data with a decoder, the data are reproduced in 4:2:2 format. Therefore, the case that the 4:2:2 format video data can be considered to be input into the information reproducing apparatus which is provided with the image processing circuit 1 of the example. At this time, the case that the structure which assumes two pixels to be processed in real time as one unit (i.e., Y0, CB, Y1, CR) might be adopted.

The pixel level may be judged to be smooth by assuming such a number of pixel elements collectively, when the comparison regarding to the brightness Y0 and Y1 is performed and the range of the referenced pixel is judged to be smooth in both case in the judgment of the smoothness of the referenced pixels of the operation of the image processing circuit 1c of the third modified example.

The image processing circuit 1c shown in FIG. 12 is a structure that performs judgment whether the pixel is valid or not by treating each elements of the pixel level collectively. The image processing circuit 1c of the third modified example shown in FIG. 12 is typically provided with the same structure as the basic structure example, the modified example and the second modified example explained above, and can achieve the same effects.

Moreover, according to the image processing circuit 1c of the third modified example the judgment whether the pixel is valid or not and the judgment whether to be smooth or not is performed by treating two elements of the brightness as the pixel level collectively. More specifically, when both of the difference value between the focused pixel and the referenced pixel with respect to the brightness Y0 and the brightness Y1 calculated respectively are less than or equal to the first thresholds, a referenced pixel that has such pixel level is judged to be a valid pixel. Moreover, when the number of referenced pixels that both of the brightness Y0 and the brightness Y1 are less than or equal to the first thresholds is more than or equal to the second threshold, the range of the referenced pixel that has such pixel level is judged to be smooth.

FIG. 13 is a block diagram conceptually showing the configuration of the image processing circuit 1c shown in FIG. 12. As illustrated in FIG. 13, the data shows each of the brightness Y0 and Y1, and each of the color difference CB and CR is input to the computing parts 22 to 25 corresponding to each element from the line memory 21 that receives the input of the 4:2:2 format video data 20.

Each of the computing parts 22 to 25 is provided with the difference value calculating and adjusting part 100, the valid pixel counter 110, the smoothness adjusting part 120, the prominent point and edge judging part 130 and the sign extension part shown in FIG. 12 respectively. Moreover, the computing part 22 is constructed to process an element of the brightness Y0. The computing part 23 is constructed to process an element of the brightness Y1. The computing part 24 is constructed to process an element of the color difference CB. The computing part 25 is constructed to process an element of the color difference CR.

After smoothness of the referenced pixel of the element of each pixel level is judged, data that shows smoothness is input from each of the computing parts 22 to 25 to information of smoothness for multi element judging part 26.

In the information of smoothness for multi element judging part 26, the judgment whether to be smooth or not is performed by treating a number of the elements of the pixel level together, for example, whether both of the combination of the brightness Y0 and Y1 is smooth or not. At this time, elements of the pixel level that is combined may adopt various modes that includes at least an element of the pixel level that is used for the sign extension, such as a combination of the elements of the brightness, combination of the elements of the color difference, combination of all four elements mentioned above

And, as a result of the judgment with respect to the combination of a number of the elements of the pixel level, for example, if all of the elements combined is judged to be smooth, the data that shows smoothness of each of the number of the elements is input to the computing parts 22 to 25. And, the sign extension with respect to each of the elements of the pixel level is performed in each of the computing parts 22 to 25 respectively, then the sign extended video data 13 is output.

By the virtue of such construction, the sign extension using preferable referenced pixels can be performed while regulating the pixel level more preferably. Moreover, by the virtue of such construction, edge portion or the like in the video data can be detected more easily. And, appearance of the blurring in the image caused by the sign extension by using pixels that the pixel level is greatly different from the pixel of the edge portion can be avoided

Incidentally, in the third modified example, it may be constructed to be similar to the above-mentioned basic composition example with respect to the part not especially described.

### (5) A Specific Example of the Information Reproducing Apparatus

Next, an information reproducing apparatus 2 of the embodiment will be explained with referring to FIG. 13. FIG. 13 is a block diagram conceptually showing the basic structure of the information reproducing apparatus 2 of the embodiment.

The information reproducing apparatus 2 of the embodiment is an equipment such as a personal computer or a work station provided with the image processing circuit 1 mentioned above, for reproducing video data recorded on a information recording medium such as DVDs and Blu-Ray discs. Moreover, in other specific example, it is a household equipment such as digital television that receive digital broadcasting or the like and reproduce the video data. Equipment of mentioned above is provided within a controlling device (such as CPU) to control the output of the image. It can reproduce the video data suitably while achieving various effects mentioned above because the controlling device is provided with the image processing circuit 1.

The basic structure of the information reproducing apparatus 2 which has the function to reproduce the data recorded on the optical disc 50 will be explained as one specific example of the information reproducing apparatus of the embodiment as follows.

The information reproducing apparatus 2 is provide with a disc drive 30 which is loaded the optical disc 50 actually and reproduces the data and a host computer 40 such as a personal computer for controlling the reproduction of data at the disc drive 30, as shown in FIG. 14.

The disc drive 30 is constructed to be provided with an optical disc 50, a spindle motor 31, an optical pickup (PU: Pick up) 32, a signal recording/reproducing part 33, a CPU34, a memory 35, a data input/output part 36, and a bus 37. Moreover, a host computer 40 is constructed to be provided with an operation/display controlling part 41, a CPU 42, a memory 43, a data input/output part 44, and a bus 45.

The spindle motor 31 works when accessing the optical disc 50 by rotating or stopping the optical disc 50. More specifically, the spindle motor 31 is constructed to rotate or stop the optical disc 50 at a certain speed by receiving a spindle servo by a servo unit or the like which is not shown in the figure.

The optical pickup 32 is provided a laser diode (LD: Laser Diode), a photo detector (PD: Photo Detector), and a collimator lens and an object lens, each of which is not shown in the figure, in order to reproduce the data recorded on the optical disc 50. More specifically, the laser diode irradiates laser light LB to the optical disc 50 at a certain reproduction power when reproducing the data. The irradiated laser light LB is reflected on the recording surface of the optical disc 50. It reproduces the data by receiving the reflected laser light with the photo detector.

The signal recording/reproducing part 33 reproduces the data recorded on the optical disc 50 by controlling the spindle motor 31 and the optical pickup 32 while receiving the control of CPU 34. More specifically, the signal recording/reproducing part 33 is provided with a laser diode driver (LD driver), a head amplifier, and the like. The LD driver drives the laser diode built in the optical pickup 32 by generating, for example, a drive pulse. The head amplifier amplifies the output signal of the optical pickup 32, i.e., the reflected light of the laser light, and outputs the amplified signal.

The CPU 34 is connected to the signal recording/reproducing part 33, the memory 35 and the data input/output part 36 via the bus 37, and controls the entire disc drive 30 by giving instructions to various parts. In general, software or firmware for operating the CPU 34 is stored in the memory 35.

The memory 35 is used in the entire data processing on the disc drive 30, including a buffer area for the record data, an area used as an intermediate buffer when data is converted into the data that can be used on the signal recording/reproducing part 33, and the like. Moreover, the memory 35 is provided with: a Read Only Memory (ROM) area into which a program for performing an operation as a recording device, i.e., firmware is stored; a buffer for temporarily storing the record/reproduction data; a Random Access Memory (RAM) area into which a parameter required for the operation of the firmware program or the like is stored; and the like.

The data input/output part 36 controls the data input/output from the host computer 40 with respect to the disc drive 30. A drive control command, which is issued from the external host computer 40 connected to the disc drive 30 via an interface, such as a SCSI (Small Computer System Interface) and an ATAPI (AT Attachment Packet Interface), is transmitted to the CPU 34 through the data input/output part 36. Moreover, the data for recording is also exchanged with the host computer 40 through the data input/output part 36.

The operation/display controlling part 41 performs the reception of the operation instruction with respect to the host computer 40 and display and sends the instructions for reproducing the data or the like to the CPU 41.

The CPU 42 sends a control command to the disc drive 30 through the data input/output part 44 on the basis of the instruction information from the operation/display controlling part 41, to thereby control the entire disc drive 30. In the same manner, the CPU 42 can send a command of requiring the disc drive 30 to send the operation condition to the host computer 40, to the disc drive 30. Because of this, it is possible to recognize the operation condition of the disc drive 30, such as during recording and during reproduction, therefore the CPU 42 can output the operation condition of the disc drive 30, to the display panel, such as a fluorescent tube and a LCD, through the operation/display controlling part 41.

In addition, the CPU 42 is constructed to be provided with the image processing circuit 1 of the example mentioned above. By this, it can output the video data to the operation/display controlling part 41 while performing the sign extension explained above suitably on the video data reproduced from the optical disc 50.

The memory 43 is a storage device used by the host computer 40, and is provided within a ROM area into which a firmware program, such as BIOS (Basic Input/Output System), is stored; and a RAM area into which a parameter required for the operation of an operating system, an application program, or the like is stored; and the like. Moreover, the information reproducing apparatus 2 may be connected to an outer recording device such as a hard disc which is not shown in the figure, via the data input/output part 44.

As explained above, the information reproducing apparatus 2 of the example can reproduce the digital video data recorded on the optical disc 50 suitably while achieving various effects mentioned above because it is provided the image processing circuit 1 of the example.

Incidentally, in the explanation above and the FIG. 14, the image processing circuit 1 of the example is provided in the CPU 42, however, the image processing circuit 1a of the modified example or the image processing circuit 1b of the second modified example may be provided instead. According to such construction, the reproduction of the digital video data can be performed while achieving various effects of the modified example or the second modified example.

Moreover, in the explanation above and the FIG. 14, the information reproducing apparatus 2 such as a DVD player and a Blu-ray player which reproduces video data recorded on the optical disc 50 such as a DVD or a Blu-ray disc is explained. However, an information recording/reproducing apparatus such as a DVD recorder and a Blu-ray recorder which is able to record information on the optical disc, in addition to reproduces the video data recorded on the optical disc 50, may also be one example of the information reproducing apparatus on the invention.

Moreover, the equipment such as digital televisions which reproduces video data input via a network or broadcasting other than the video data recorded on the optical disc 50, may also be one example of the information reproducing apparatus on the invention.

Moreover, in the present invention, various changes may be made, if desired, without departing from the essence or spirit of the invention which can be read from the claims and the entire specification. An image processing circuit, an information reproducing apparatus, a computer program and an information reproducing method which involve such changes, are also intended to be within the technical scope of the present invention.

1. An image processing circuit comprising:
a difference calculating device for calculating difference value between a pixel level of a focused pixel and a pixel level of a referenced pixel;
a first comparing device for comparing the difference value with a first threshold;
a counting device for judging the referenced pixel that the difference value is less than or equal to the first threshold to be a valid pixel, and counting the number of the valid pixels;
a second comparing device for comparing the number of the valid pixels with a second threshold;
a correcting device for correcting the pixel level of the focused pixel, in case that the number of the valid pixels is more than or equal to a second threshold; and
a third comparing device for comparing an absolute value of a maximum difference value which is the difference value between the pixel level of the focused pixel and the pixel level of the referenced pixel that the absolute value of the different value becomes the maximum, with a third threshold; and
a prominent point judging device for judging the reference pixel that the absolute value of the maximum difference value is more than or equal to the third threshold, as a prominent point, and
the correcting device does not perform correction of the pixel level of the focused pixel in case that one of the referenced pixels is judged to be the prominent point.

2. The image processing circuit according to claim 1, wherein
the correction device corrects the pixel level of the focused pixel by adding the value which is calculated by dividing the sum of the difference value between the pixel level of the focused pixel and the pixel level of the valid pixel by a predetermined value, to the pixel level of the focused pixel.

3. The image processing circuit according to claim 2, wherein
the correcting device determines the predetermined value by multiplying the number of the valid pixels by a predetermined coefficient value.

4. (canceled)

5. The image processing circuit according to claim 1, further comprising: a pixel selecting device for selecting the reference pixel from pixels located adjacent to the focused pixel.

6. The image processing circuit according to claim 5, wherein
the pixel selecting device selects the reference pixel from pixels located adjacent to the focused pixel based on at least one of the comparison of the difference values performed by the first comparing device or the comparison of the number of the valid pixels performed by the second comparing device.

7. The image processing circuit according to claim 6, wherein
the pixel selecting device weights each of the referenced pixels depending on the distance from the focused pixel, and at least one of (i) the comparison of the difference values performed by the first comparing device, (ii) the comparison of the number of the valid pixels performed by the second comparing device and (iii) the addition of the sum of the difference value to the pixel level of the focused pixel, is performed depending on the weighting.

8. The information reproducing apparatus wherein said information reproducing apparatus is provide with an image processing circuit comprising:
a difference calculating device for calculating difference value between a pixel level of a focused pixel and a pixel level of a referenced pixel;
a first comparing device for comparing the difference value with a first threshold;
a counting device for judging the referenced pixel that the difference value is less than or equal to the first threshold to be a valid pixel, and counting the number of the valid pixels;
a second comparing device for comparing the number of the valid pixels with a second threshold; and
a correcting device for correcting the pixel level of the focused pixel, in case that the number of the valid pixels is more than or equal to a second threshold.

9. A non-transitory computer-readable storage medium with a computer program of instructions for tangibly embodying a program of instructions executable by a computer provided in an information reproducing apparatus wherein said information reproducing apparatus is provide with an image processing circuit comprising: a difference calculating device for calculating difference value between a pixel level of a focused pixel and a pixel level of a referenced pixel; a first comparing device for comparing the difference value with a first threshold; a counting device for judging the referenced pixel that the difference value is less than or equal to the first threshold to be a valid pixel, and counting the number of the valid pixels; a second comparing device for comparing the number of the valid pixels with a second threshold; and a correcting device for correcting the pixel level of the focused pixel, in case that the number of the valid pixels is more than or equal to a second threshold,
said computer program makes the computer at least one portion of the difference calculating device, the first comparing device, the counting device, the second comparing device and the correction device.

10. An image processing method comprising:
a difference calculating process of calculating difference value between a pixel level of a focused pixel and a pixel level of a referenced pixel;
a first comparing process of comparing the difference value with a first threshold;
a counting process of judging the referenced pixel that the difference value is less than or equal to the first threshold to be a valid pixel, and counting the number of the valid pixels;
a second comparing process of comparing the number of the valid pixels with a second threshold; and
a correcting process of correcting the pixel level of the focused pixel, in case that the number of the valid pixels is more than or equal to a second threshold.
